(19) United States
(12) Patent Application Publication
(10) Pub. No.: US 2016/0097423 A1
(43) Pub. Date: Apr. 7, 2016

(54) BEARING ASSEMBLY, MOUNTING OF A BEVEL PINION SHAFT

(71) Applicant: AKTIEBOLAGET SKF, Göteborg (SE)

(72) Inventors: Helmut Hauck, Euerbach (DE); Thomas Wolf, Schweinfurt (DE)

(73) Assignee: AKTIEBOLAGET SKF, Göteborg (SE)

(21) Appl. No.: 14/889,601

(22) PCT Filed: Apr. 24, 2014
(86) PCT No.: PCT/EP2014/058340

§ 371 Date: Nov. 6, 2015

(30) Foreign Application Priority Data
May 6, 2013 (DE) 10 2013 208 208.8

(51) Int. Cl. F16C 19/54; F16C 33/58; F16C 19/18; F16C 25/08

(52) U.S. Cl. CPC F16C 19/546; F16C 25/083; F16C 33/588; F16C 19/182

(57) ABSTRACT

A bearing assembly for supporting a shaft includes a bearing outer ring assembly, a bearing inner ring assembly, a first rolling-element row configured to support the bearing outer ring assembly with respect to the bearing inner ring assembly in an axial or a radial direction, and a second rolling-element row configured to support the bearing outer ring assembly with respect to the bearing inner ring assembly in a direction that differs from the axial direction and differs from the radial direction. The bearing outer ring assembly and/or the bearing inner ring assembly is separated from the first or the second rolling-element row by a bowl-shaped component that includes at least one raceway for the first rolling-element row or for the second rolling-element row.

Exemplary embodiments of the present invention lie in the field of the bearing assembly, in particular of the bearing assembly for the supporting of shafts that are subject to axial and radial loads.

Axial and radial load cases for bearings are known from the prior art. For example, these can arise in transmissions whenever plane of rotation is changed via a translation. This can occur, for example, in pinions in interaction with ring gears. Such an example is known, for example, from the publication DE 198 39 481 C2. This document shows a transfer case for a motor vehicle, including a pinion shaft that is supported in a housing via two mutually spaced and axially preloaded rolling-element bearings. The pinion shaft is furthermore provided with a pinion, which drives a differential supported in a transmission housing. Here axle shafts are also supported in the differential, which are in operative connection with one another via output- and differential-gears. Here the rolling-element bearings are configured as unilaterally loadable double row tandem angular contact ball bearings, which are set in back-to-back arrangement with respect to each other.

Furthermore, angular contact ball bearings are known, for example, from the document DE 102 39 742 B4. The publication shows a unilaterally loadable double angular contact ball bearing including a one-part outer bearing ring and a one-part inner bearing ring, as well as two cage and ball assemblies disposed between the bearing rings, which cage and ball assemblies comprise by two rows, each guided in a cage, of bearing balls. The bearing balls are supported on shoulders on the bearing rings, which shoulders lie in the direction of the acting force, wherein the diameter of the rolling elements and radii of their ball raceways are differently sized, and the two cage and ball assemblies have differently sized pitch-circle radii. Here the two cages are configured as window cages, made of a plastic, including the ball-bearing-receiving pockets and connectable using one of the bearing rings into a captive partial bearing component. This can occur in that one of the two cages is configured on its axial inwardly oriented end with a plurality of spacers spaced uniformly from one another in the circumferential direction and preventing an axial displacing of the other cage. The cage can further include a plurality of retaining lugs spaced uniformly from one another in the circumferential direction, which engage in an associated groove of the inner or of the outer bearing ring.

It is disadvantageous in these known concepts that the friction-minimizing or the load-optimizing of this bearing is limited. In other words, the durability or resistance of this bearing can be further improved.

It is therefore the object of the present invention to provide an improved concept for a bearing that is loaded both in the radial and in the axial direction.

Exemplary embodiments of the present invention are based on the recognition that friction-reducing or -minimizing and also load-adapting or -optimizing in ball- or rolling-element-bearings can be improved if the loads act perpendicularly on the bearing. In other words, it is a recognition that an angular contact ball bearing has, in a design-dependent manner, an inferior degree of efficiency than a purely radially or an axially loaded bearing. This applies in particular if, due to higher loads, multi-row angular contact ball bearings, such as, for example, tandem bearings, are used. It is a further recognition that in a rolling-element bearing including more than one rolling-element row, e.g., in a ball bearing including more than one ball row, e.g., one row can be configured as an angular bearing, such as, e.g., an angular contact ball bearing, and a further row can be configured as a purely radial- or axial-bearing.

Exemplary embodiments therefore provide a bearing assembly for supporting a shaft, which bearing assembly includes a bearing-outer-ring assembly, a bearing-inner-ring assembly, a first rolling-element row for supporting the bearing-outer-ring assembly with respect to the bearing-inner-ring assembly in the axial or radial direction, and a second rolling-element row for supporting the bearing-outer-ring assembly with respect to the bearing-inner-ring assembly in a direction that differs from the axial and the radial direction.

All conceivable rolling-element bearings can be used as rolling-element bearings here, such as, for example, ball bearings, tapered roller bearings, cylindrical bearings, barrel roller bearings, etc. Accordingly, in exemplary embodiments a bearing-outer-ring assembly is supported with respect to a bearing-inner-ring assembly using at least two rolling-element rows, of which one is configured for the supporting of substantially radial or axial loads and the other is configured for the supporting of loads from a direction different therefrom. In other words, there can be an angle between the bearing rows, which falls between 0 and 90°. In some exemplary embodiments it is conceivable that a bearing row as pure radial ball bearing and a further bearing row as angular bearing having an angle of nearly 90°, i.e., also with an axial bearing, are combined into a multiple-row bearing unit or bearing assembly. However, in exemplary embodiments angles are conceivable that combine exactly-radial or -axial components with intermediate-angle components, i.e., having angles between 0 and 90°. The angle between the first, e.g., purely-radial or -axial bearing row and the second bearing row falls in the range 0<α≦90°; it can preferably fall in the range 0<α≦65°.

Exemplary embodiments can therefore provide a bearing assembly that is configured compact despite multi-row rolling elements. In some exemplary embodiments reduced assembly costs can thereby be realized. In further exemplary embodiments a better power density performance can be achieved. This can be achieved, for example, in that with the same construction size higher loads can be supported, or else the construction size can be reduced with the load remaining the same.

Exemplary embodiments therefore provide a bearing or a bearing assembly that is embodied as a multi-row bearing unit. The bearing unit is therefore comprised of at least one radial bearing row or an axial bearing row, and a further bearing row whose load direction forms an angle to the first bearing row that falls between 0 and 90°.

In exemplary embodiments the bearing-outer-ring assembly of the bearing assembly can include two raceways for rolling elements of the first and of the second rolling-element rows, wherein the bearing-outer-ring assembly can be configured one-piece or multiple-piece. In exemplary embodiments the same can also apply to the bearing-inner-ring assembly, i.e., it can also include two raceways for rolling elements of the first and of the second rolling-element rows, and the bearing-inner-ring assembly can also be configured one-piece or multiple-piece. In this respect exemplary embodiments also comprise bearing units or bearing assemblies including a one-part inner ring for at least two bearing rows, and a multiple-part outer ring, or bearing units including a one-part outer ring and at least two bearing rows including a multiple-part inner ring.

As already mentioned above, in further exemplary embodiments the rolling elements of the first and of the second rolling-element rows can be configured as balls, cones, cylinders, barrels, or needles, wherein the rolling elements of the first and of the second rolling-element rows can be configured differently. In other words, exemplary embodiments provide bearing assemblies wherein the first rolling-element row comprises rolling elements of the same size and design as the second rolling-element row. In other exemplary embodiments the rolling elements of the first and of the second rolling-element rows can also be different. Here it is conceivable, for example, that they have the same design, for example, ball-type design, but they differ in their size. In further exemplary embodiments it is conceivable that the rolling elements of the first rolling-element row and the rolling elements of the second rolling-element row also differ in their design. In such exemplary embodiments, cylindrical rolling elements can be combined, for example, with balls, or similar.

In further exemplary embodiments the bearing-outer-ring assembly and/or the bearing-inner-ring assembly can include a recess including a raceway for one of the rolling-element rows. In other words, at least one of the raceways, or also both, can be incorporated directly into the respective bearing-ring assembly. In other exemplary embodiments at least one of the bearing-ring assemblies can be separated from the first or the second rolling-element row by a bowl- or pot-shaped component. The component can be formed, for example, by a metal plate. The bowl- or pot-shaped component can include at least one raceway for one of the rolling-element rows. In other words, it can be provided in exemplary embodiments that an additional component, for example, in the shape of a bowl, is provided in order to form at least one of the raceways or even both raceways. This component can then be attached either in the bearing-outer-ring assembly or the bearing-inner-ring assembly in order to form the raceways flat there.

In further exemplary embodiments the bearing assembly can include at least one cage for guiding the first or the second rolling-element rows. Here separate or also combined or coupled cages can be provided, which are adapted to the respective rolling elements and bearing-ring assemblies. Such a bearing cage can include a guiding means that interacts with the bearing-outer-ring assembly or the bearing-inner-ring assembly for guiding the bearing cage relative to the bearing-outer-ring assembly or the bearing-inner-ring assembly. This can have the advantage that the raceway of the respective rolling element can be guided relative to one of the bearing assemblies. This can cause corresponding advantages with respect to the wear and the durability of the bearing. Further exemplary embodiments provide a bearing assembly for supporting a pinion shaft, which bearing assembly includes a first bearing assembly according to the above description and a second bearing assembly, wherein the first bearing assembly is configured for supporting the pinion shaft on a side facing the pinion, and the second bearing assembly is configured for supporting the pinion shaft on a side facing away from the pinion. Moreover, in the first bearing assembly the first rolling-element row can be located on the side of the bearing assembly facing toward the pinion. Accordingly, the second rolling-element row of the first bearing assembly can be located farther from the pinion than the first rolling-element row. Accordingly, in some exemplary embodiments the second rolling-element row can also be located on the side of the bearing assembly facing away from the pinion.

In other words, exemplary embodiments can provide the rolling-element bearing assembly of a pinion shaft, for example, of a motor-vehicle (motor-vehicle)-driveline. Here the pinion shaft can be supported by using a plurality of bearing assemblies, for example, with respect to a housing. In exemplary embodiments such a bearing assembly can comprise a stable or deformable spacer between the first bearing assembly and the second bearing assembly. Such a spacer can offer the advantage that the two bearing assemblies are held at a defined spacing, so that the corresponding supports can be defined or set with respect to the housing and the corresponding force distribution. In this respect in exemplary embodiments the rolling-element bearing assembly can provide a deformable spacer between the two bearings or bearing assemblies. In other words, the spacer can be deformable.

In further exemplary embodiments the bearing assembly can then further comprise a preload element, which is configured for axial preloading of the first bearing assembly with respect to the second bearing assembly. In this respect the preload element can be used in order to deform the spacer, i.e., in order to set an axial preload on the two bearing assemblies and the spacer located therebetween. Exemplary embodiments can therefore also provide a rolling-element bearing with a preload element that serves, seated on the shaft, for axial preload of the two bearings or bearing assemblies on the two sides of the pinion shaft. Here a screw element can be used, for example. As already mentioned above, exemplary embodiments of the bearing assembly can be used as a rolling-element bearing assembly, for example, on the pinion-head side of a pinion shaft. A further rolling-element bearing or a further rolling-element bearing assembly can be used on the corresponding opposite side. The second, in this respect, bearing assembly can comprise, for example, an angular bearing, a radial bearing, a bearing assembly according to the above description, or a bearing assembly disposed in minor image with respect to the first bearing assembly. For example, angular contact ball bearings can also be used here. As already mentioned, in exemplary embodiments rolling-element bearings of the same principle can be found on both sides of the pinion shaft.

In some exemplary embodiments a rolling-element bearing of the same principle can be used on both sides of the pinion shaft, which rolling-element bearing comprises a one-part outer ring and a one-part inner ring. In further exemplary embodiments the respective bearing or bearing assembly can be sealed, oil-lubricated, grease-lubricated, etc. Furthermore, a housing of the bearing, i.e., for example, of the bearing-ring assembly or also a housing wherein the corresponding bearing assembly is attached, can be formed, for example, from metal, e.g., from a light metal such as aluminum. Furthermore, exemplary embodiments provide a pinion shaft including at least one bearing ring of the first or of the second bearing assembly according to one of the above-described bearing assemblies. This can offer the advantage that the manufacturing costs are reduced since the bearing-inner-ring assembly is provided directly on the pinion shaft.

Further advantageous designs are described below with reference to the exemplary embodiments depicted in the drawings, but are generally not altogether limited to said exemplary embodiments.

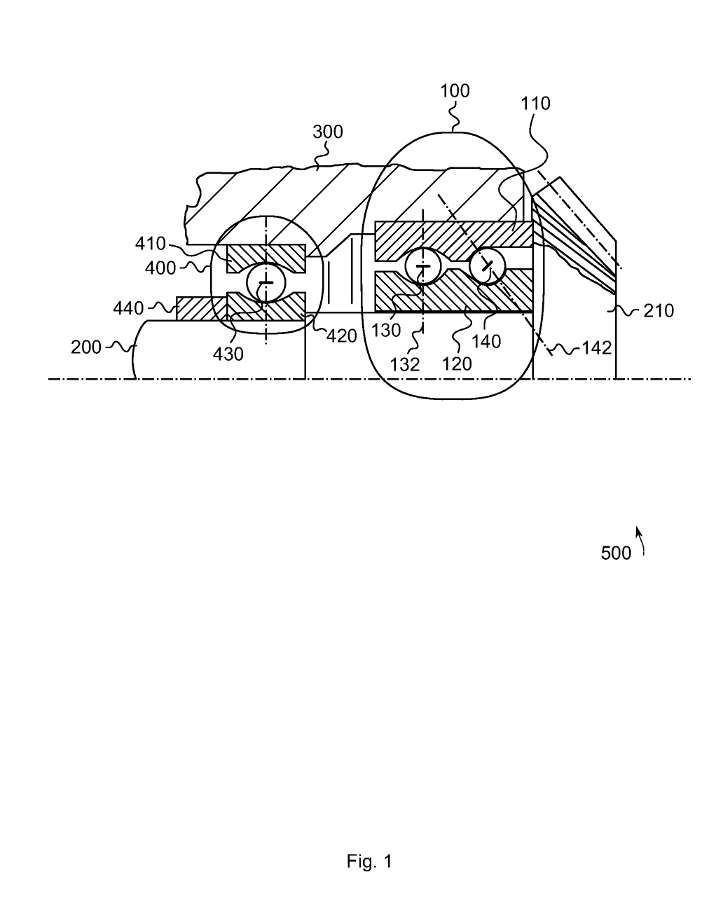

FIG. 1 shows an exemplary embodiment of a bearing assembly on a pinion shaft;

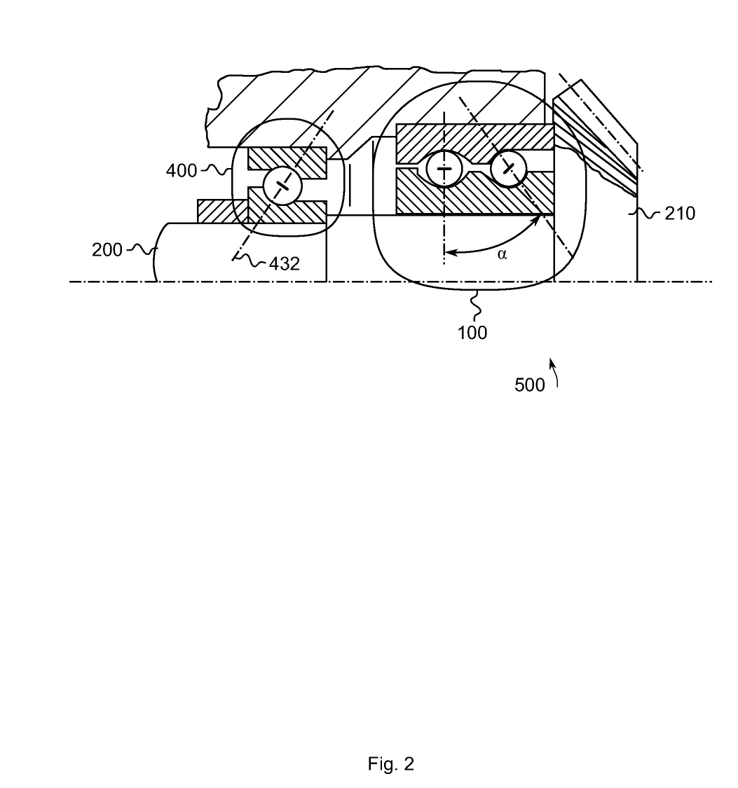

FIG. 2 shows a further exemplary embodiment of a bearing assembly on a pinion shaft with a depiction of the different pitch angle;

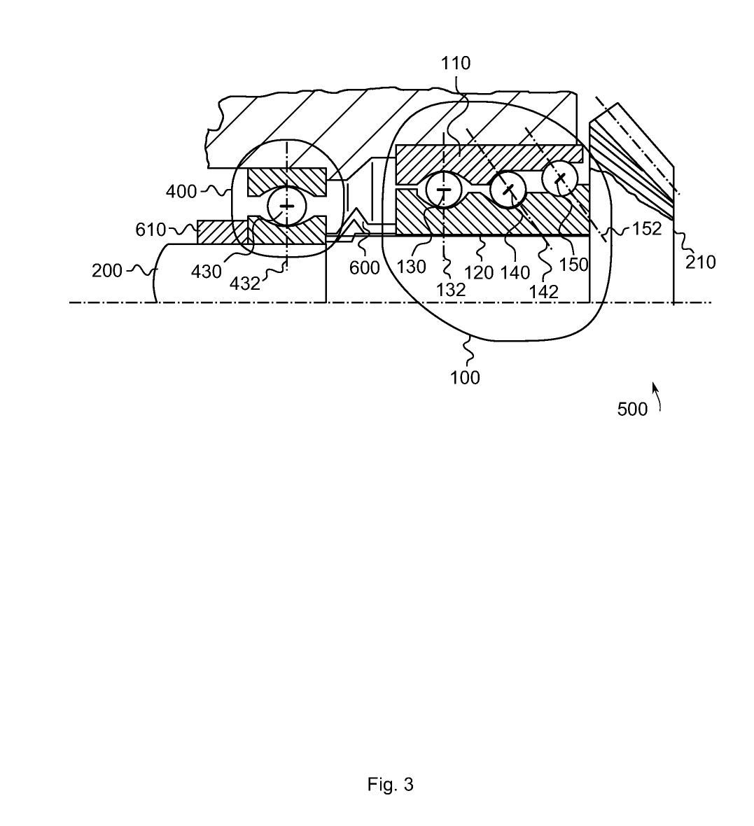

FIG. 3 shows a further exemplary embodiment of a bearing assembly on a pinion shaft including a second bearing assembly and a spacer;

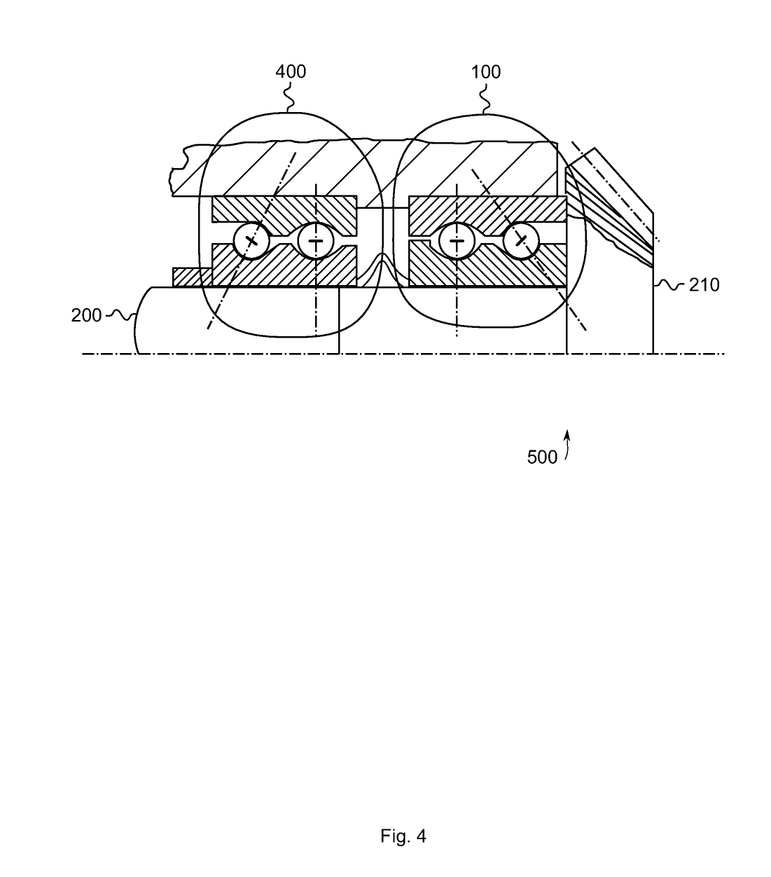

FIG. 4 shows an exemplary embodiment of a bearing assembly of a pinion shaft;

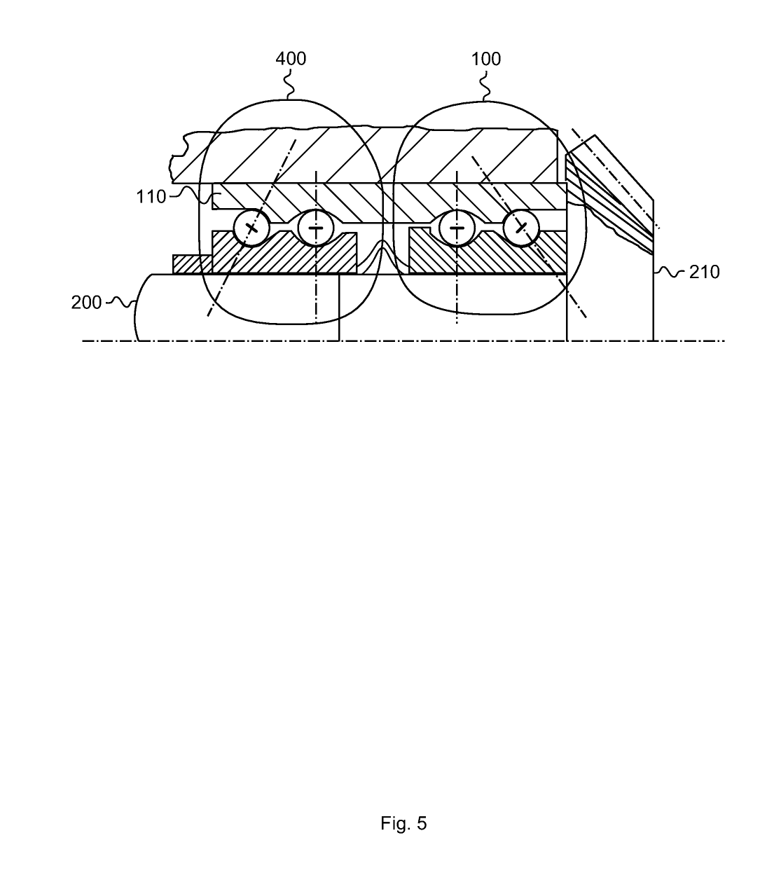

FIG. 5 shows an exemplary embodiment of a bearing assembly of a pinion shaft including a one-part bearing outer ring;

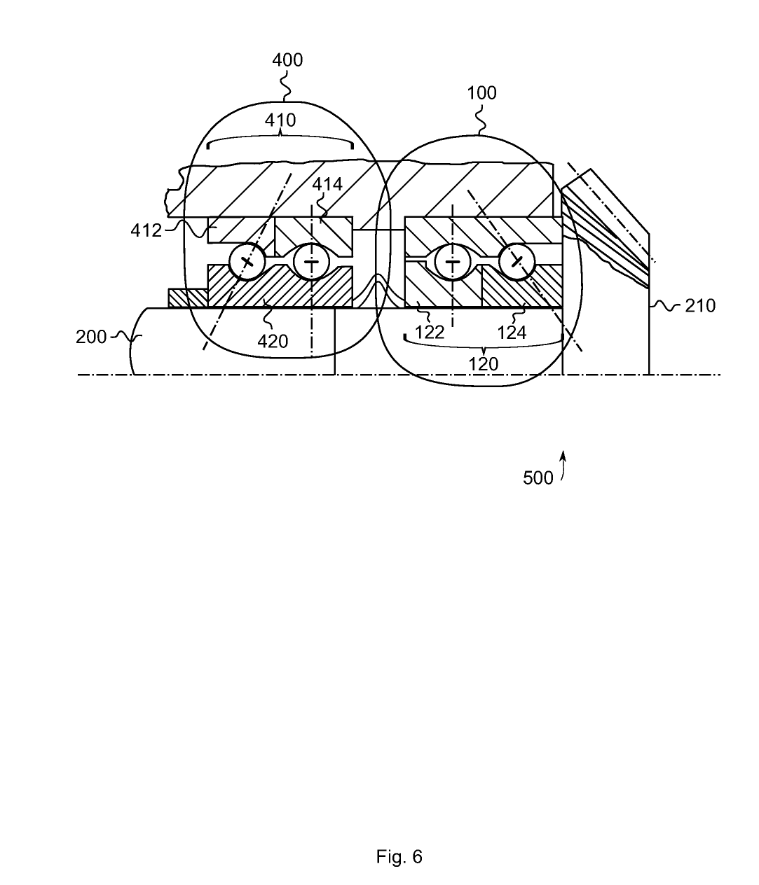

FIG. 6 shows an exemplary embodiment of a bearing assembly of a pinion shaft including differently split bearing rings;

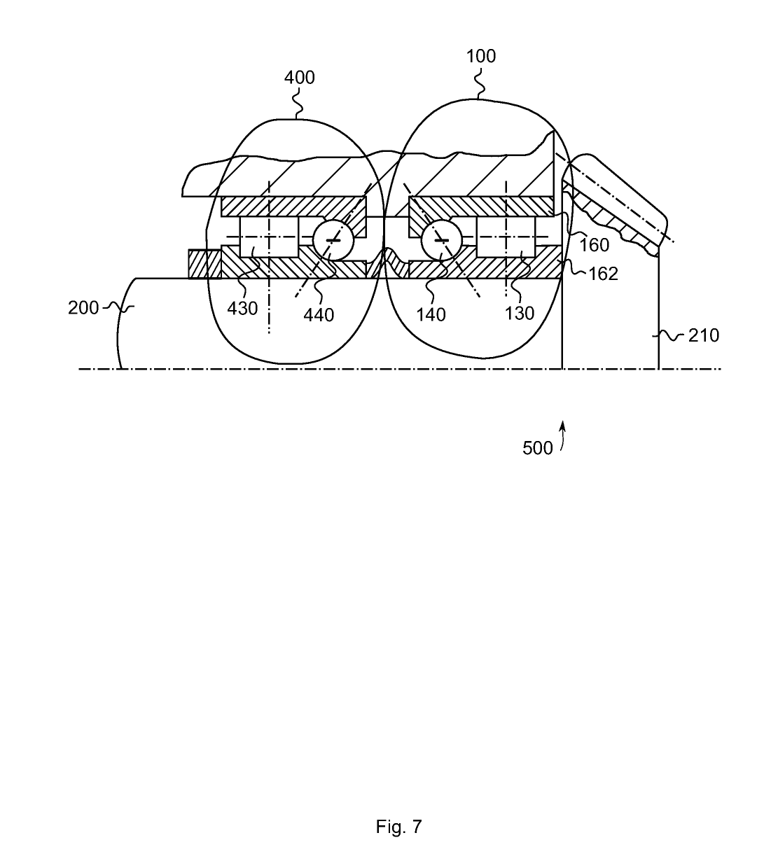

FIG. 7 shows an exemplary embodiment of a bearing assembly of a pinion shaft with the use of different rolling-element shapes inside a bearing;

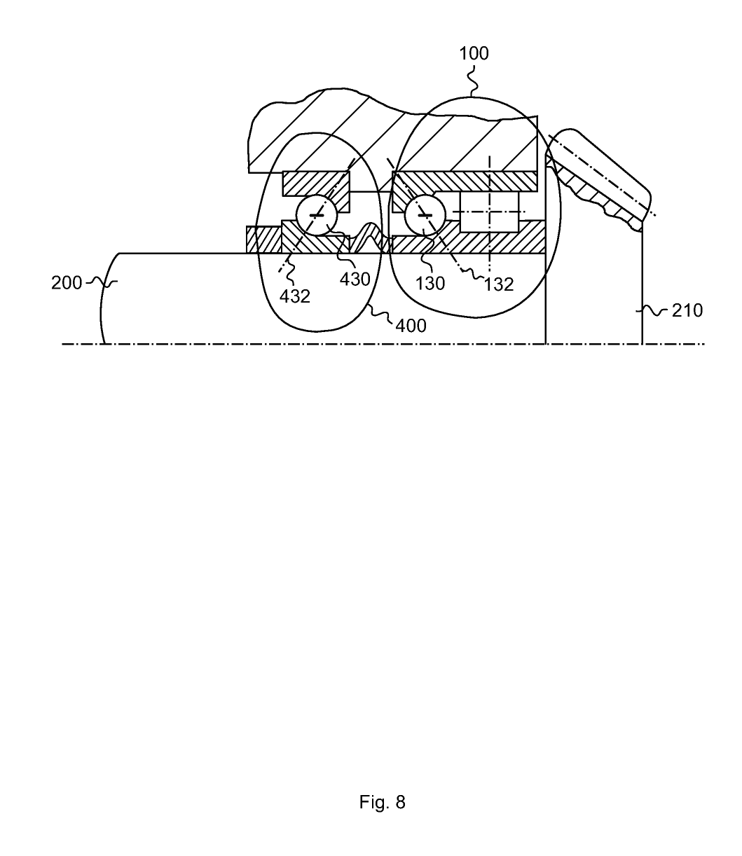

FIG. 8 shows an exemplary embodiment of a bearing assembly of a pinion shaft with the use of asymmetrical bearings;

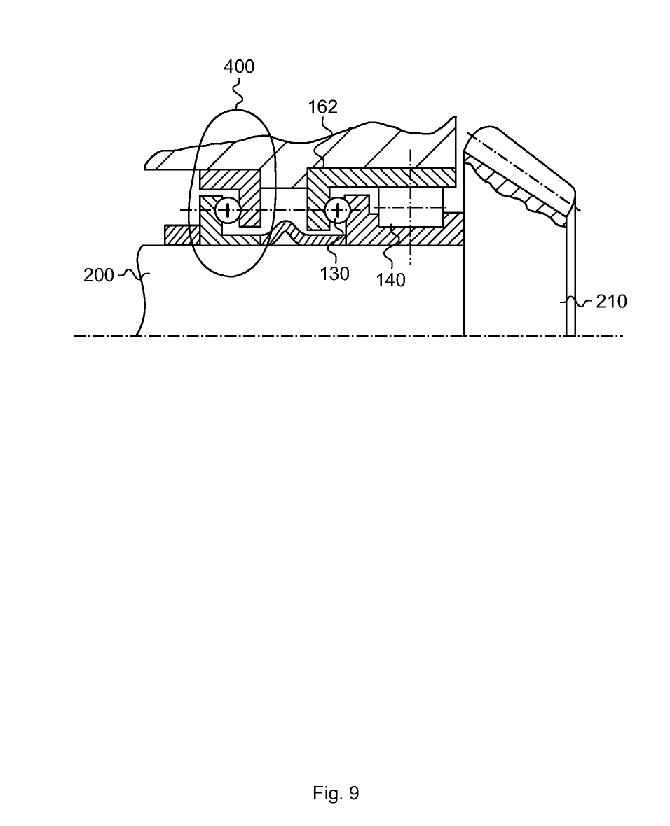

FIG. 9 shows an exemplary embodiment of a bearing assembly of a pinion shaft including radial and axial bearings;

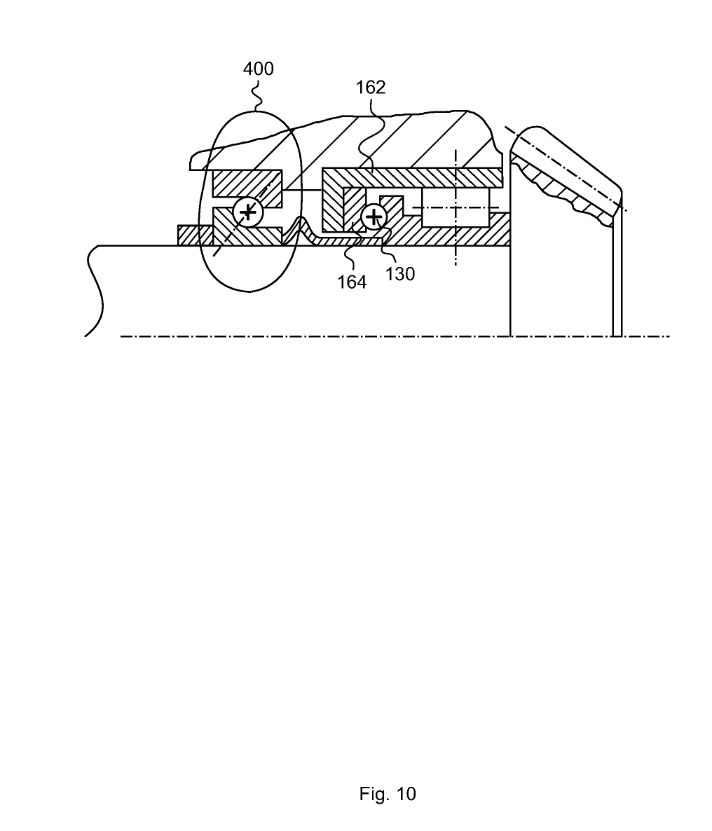

FIG. 10 shows an exemplary embodiment including a bowl-shaped component;

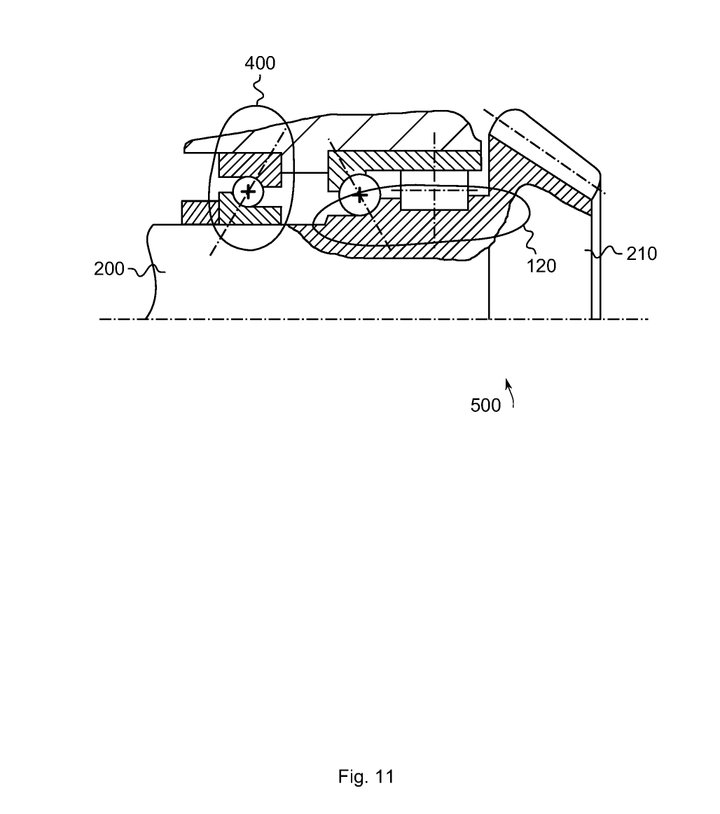

FIG. 11 shows an exemplary embodiment of a pinion shaft including an integrated bearing inner ring;

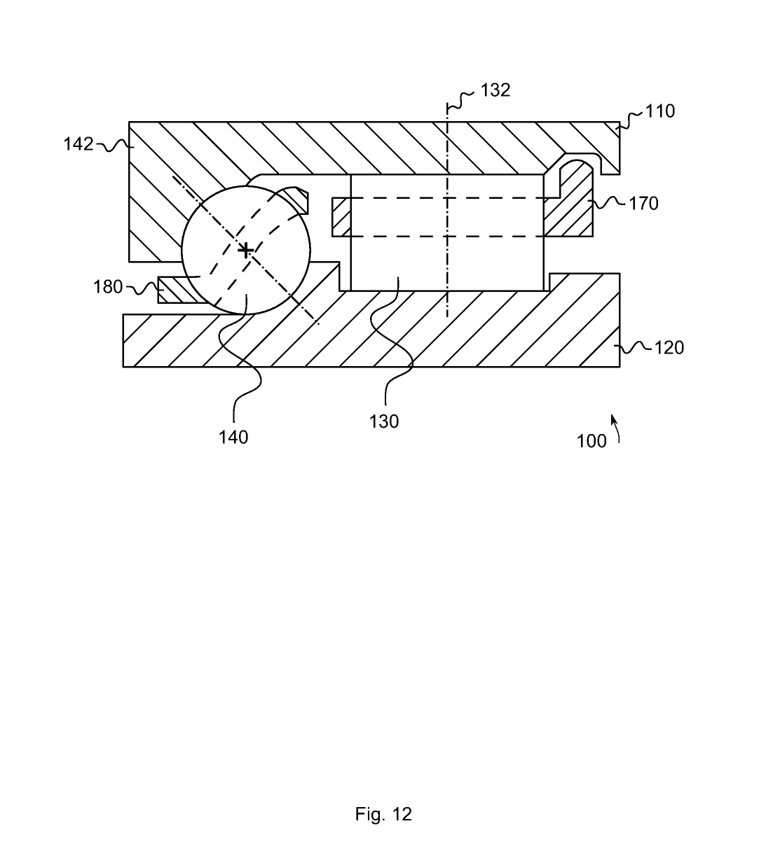

FIG. 12 shows an exemplary embodiment of a bearing assembly including a bearing cage, a cylindrical-roller row and a ball row;

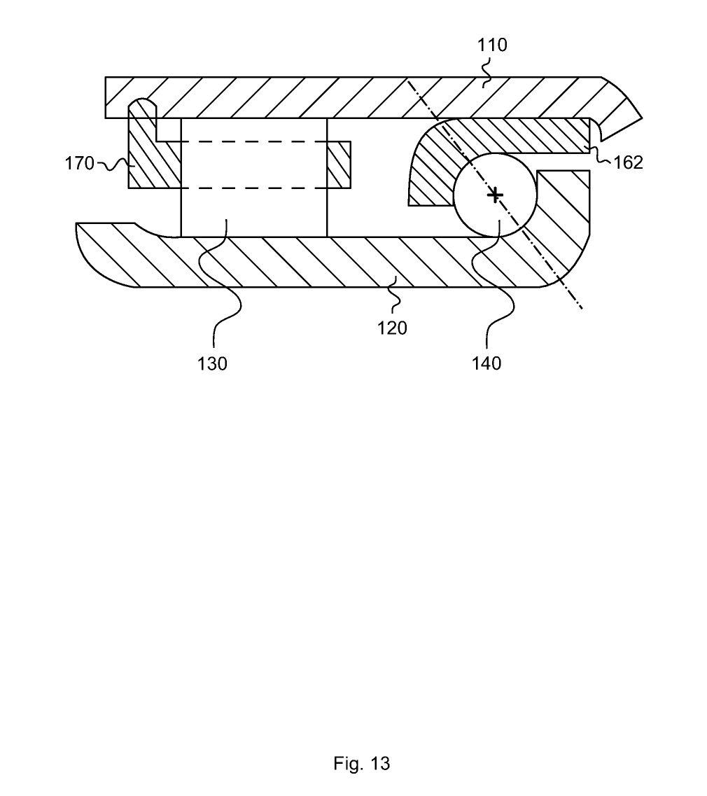

FIG. 13 shows an exemplary embodiment including mixed rolling elements and a bowl-shaped component;

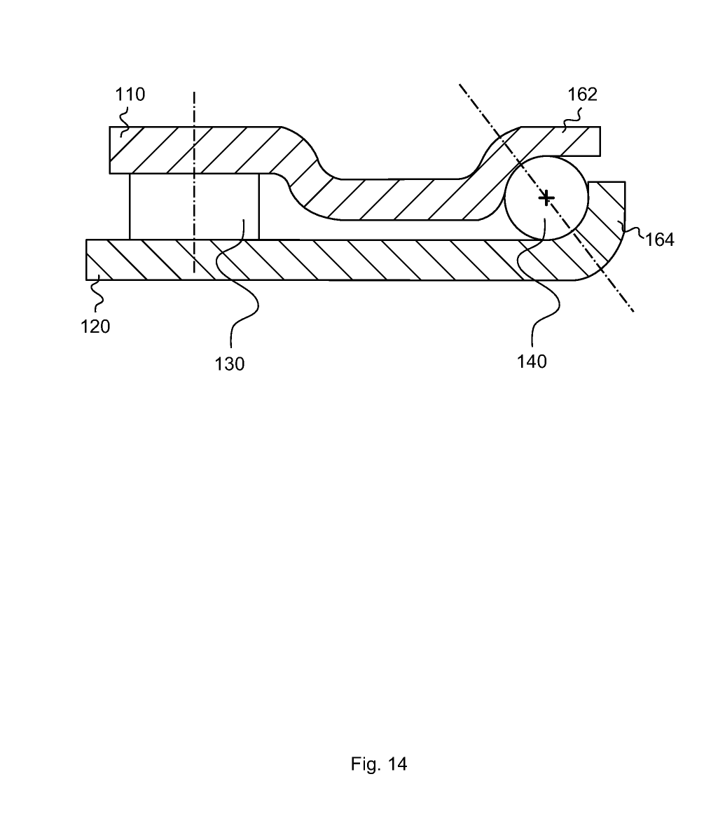

FIG. 14 shows a further exemplary embodiment of two bowl-shaped components; and

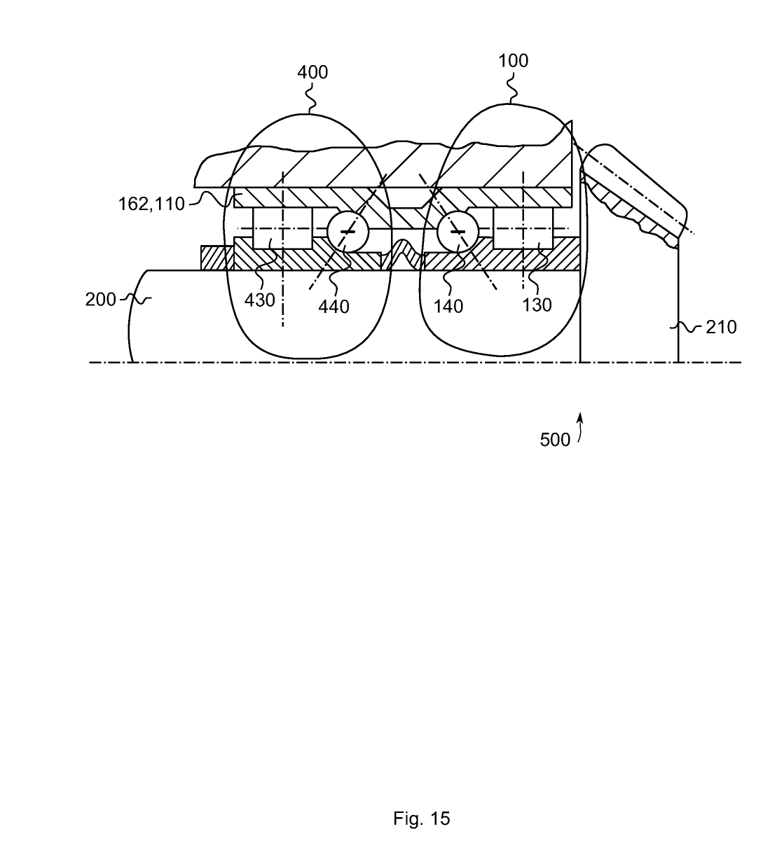

FIG. 15 shows an exemplary embodiment including two bowl-shaped components wherein one bowl-shaped component forms four raceways for a bearing-outer-ring assembly.

In the following description of the accompanying Figures, which show exemplary embodiments of the present invention, identical reference numbers indicate identical or comparable components. Furthermore, summarizing reference numbers may be used for components and objects that appear multiple times in an exemplary embodiment or in a drawing, but that are described together in terms of one or more common features. Components or objects that are described with the same or summarizing reference numbers can be embodied identically, but also optionally differently, in terms of individual, multiple, or all features, their dimensions, for example, as long as the description does not explicitly or implicitly indicate otherwise.

FIG. 1 shows a bearing assembly 100 for supporting a shaft 200, which in the present exemplary embodiment is configured as a pinion shaft. The bearing assembly 100 comprises a bearing-outer-ring assembly 110 and a bearing-inner-ring assembly 120. Between the bearing-outer-ring assembly 110 and the bearing-inner-ring assembly 120 a first rolling-element row 130 is located for supporting the bearing-outer-ring assembly 110 with respect to the bearing-inner-ring assembly 120 in the axial or radial direction, wherein in the exemplary embodiment of FIG. 1 initially the radial direction is illustrated, as the corresponding axis 132 illustrates. The bearing assembly 100 further comprises a second rolling-element row 140 for supporting the bearing-outer-ring assembly 110 with respect to the bearing-inner-ring assembly 120 in a direction that differs from the axial or the radial direction 132. This is illustrated in FIG. 1 by the obliquely-set axis 142, which in this exemplary embodiment extends at least approximately in the 45° direction. FIG. 1 shows, in addition, that the bearing-outer-ring assembly 110 is attached in a housing 300.

The bearing assembly 100 thus supports the pinion shaft 200, which in the exemplary embodiment of FIG. 1 comprises a pinion 210 on the right side, with respect to the housing 300. In this respect FIG. 1 also shows a bearing assembly for supporting the pinion shaft 200 using the first bearing assembly 100 according to the above description and a second bearing assembly 400. The second bearing assembly also supports the shaft 200 with respect to the housing 300. In the exemplary embodiment of FIG. 1 the second bearing assembly 400 is configured as a radial ball bearing including an outer ring 410, an inner ring 420, and a rolling-element row 430. The second bearing assembly 400 here is supported on a shaft shoulder and is attached using a clamping ring 440.

As FIG. 1 further shows, the first bearing assembly 100 is configured for supporting the pinion shaft 200 on a side facing the pinion 210, and the second bearing assembly 400 is configured for supporting the pinion shaft 200 on a side facing away from the pinion 210. The in total three rolling-element bearing rows 130 140, and 430 are each configured as ball bearings in the exemplary embodiment of FIG. 1. As the further exemplary embodiments shall show, all possible variants of bearings and rolling elements can be used here.

In the following a plurality of exemplary embodiments are described that in part include the same components as the exemplary embodiment of FIG. 1. Here identical reference numbers designate identical components. For reasons of clarity, multiple description and repeated designation of all components shall be omitted in part.

FIG. 2 illustrates a further exemplary embodiment of a bearing assembly 500 of a pinion shaft 200. The first bearing assembly 100 here is identically configured to the first bearing assembly 100 of FIG. 1. To illustrate the different angles/load directions, in FIG. 2 the angle a is marked, which angle α illustrates the oblique setting of the load relating to the second ball row 140 with respect to the first ball row 130. Furthermore, in the exemplary embodiment of FIG. 2 the second bearing assembly 400 is configured as an angular contact ball bearing. This is illustrated by the obliquely set load angle 432. In this respect it is once again clear that in this exemplary embodiment the bearing unit or the bearing assembly 100 is also comprised as a radial-bearing row, which is designated by 130 in the exemplary embodiment of FIG. 1, and comprises at least one further bearing row 140 whose load direction has an angle of 0<α≦90° with respect to this radial bearing row 130 that is purely radial in this exemplary embodiment. Exemplary embodiments here are not limited to two rolling-element rows. The angle between the first, e.g., purely-radial or -axial bearing row 130 and the second bearing row 140 falls in the range 0<α≦90°, but preferably in the range 0<α≦65°.

FIG. 3 illustrates a further exemplary embodiment wherein in turn a bearing assembly 500 for a pinion shaft 200 including a pinion 210 is shown. In the exemplary embodiment of

FIG. 3 the first bearing assembly now comprises three rolling-element bearing rows 130, 140, and 150. Here, as the axis 132 shows, the first rolling-element bearing row 130 is radially loaded, and the two subsequent rolling-element bearing rows 140 and 150 are obliquely loaded, as their two axes 142 and 152 show. It is further to be noted that the rolling-element rows 140 and 150 differ in their diameters, i.e. in this exemplary embodiment the balls of the rolling-element row 150 are smaller than the balls of the rolling-element row 140. The exemplary embodiment of FIG. 3 further illustrates a second bearing assembly 400, which is configured as a radial ball bearing including the rolling-element row 430. FIG. 3 further illustrates that a spacer 600 is located between the first bearing assembly 100 and the second bearing assembly 400. Here this spacer 600 is depicted deformable and holds the two bearing assemblies 100 and 400 at a spacing. In this respect the clamping ring, which can be referred to as preload element 610, exerts an axial force on the bearing assembly 400 and, indirectly via the spacer element 600, also on the bearing assembly 100. The two bearing assemblies 100 and 400 can thus be held under axial preload.

As the exemplary embodiments of FIGS. 1, 2, and 3 show, in the context of the bearing assembly 100 the respective bearing inner rings 120 as well as the bearing outer rings 110 can be configured one-piece. In addition, the respective one-piece-configured bearing rings can provide corresponding raceways for the rolling elements. Thus the bearing-outer-ring assemblies 110 include at least two raceways for rolling elements of the first and of the second rolling-element rows 130, 140. The same is to be observed for the bearing-inner-ring assembly 120 in the exemplary embodiments considered so far, since these also have corresponding raceways for the rolling elements of the first and second rolling-element rows 130 and 140.

A further exemplary embodiment is depicted in FIG. 4. The exemplary embodiment of FIG. 4 in turn shows the bearing assembly 500 of a pinion shaft 200 including a pinion 210, such as can be found in a motor-vehicle driveline. In the exemplary embodiment, which is shown in FIG. 4, the two bearing assemblies 100 and 400 are symmetrically configured. In other words, the bearing assembly 400 is installed on the other side of the pinion-head shaft 200, i.e., on the side facing away from the pinion 210, rotated about 180° in comparison to the bearing assembly 100. In addition to these variants an identical orientation is also conceivable in exemplary embodiments, i.e., the use of identical bearing assemblies 100 and 400.

FIG. 5 illustrates a further exemplary embodiment that builds on the exemplary embodiment of FIG. 4. In contrast to FIG. 4, in the exemplary embodiment of FIG. 5 the two bearing assemblies 100 and 400 use a common bearing outer ring, i.e., a common bearing-outer-ring assembly 110. As FIG. 5 shows, all raceways for the 4 rolling-element rows are formed in the common bearing-outer-ring assembly. In this regard the bearing assembly 100 in FIG. 5 comprises a one-part outer ring for at least two bearing rows and a multiple-part inner ring. In other exemplary embodiments a one-part inner ring for at least two bearing rows and a multiple-part outer ring are also conceivable.

FIG. 6 illustrates a further exemplary embodiment including the two bearing assemblies 100 and 400. In the exemplary embodiment of FIG. 6 the bearing assembly 100 includes a one-part bearing outer ring or a bearing-outer-ring assembly 110 including a split bearing-inner-ring assembly 120, which is composed of the two partial bearing inner rings 122 and 124. In further exemplary embodiments the bearing assembly can also be so designed as the bearing assembly 400 is depicted in FIG. 6. This includes, as bearing-outer-ring assembly 410, a split bearing outer ring including the parts 412 and 414 in interaction with a one-piece-configured or one-part bearing inner ring 420.

FIG. 7 illustrates a further exemplary embodiment of a bearing assembly 500 including the two bearing assemblies 100 and 400. Here the bearing assemblies in the exemplary embodiment of FIG. 7 include different rolling-element rows 130, 140, 430, and 440. In this exemplary embodiment the first rolling-element row 130 is configured as a conical-element row or cylindrical-roller row 130. The second rolling-element row 140 is configured as a ball-bearing row. Generally in exemplary embodiments the rolling elements of the first and of the second rolling-element rows 130, 140 can be configured, for example, as balls, cones, cylinders, barrels, or needles. As the exemplary embodiment of FIG. 7 shows, the rolling elements of rolling-element rows 130 and 140 can also be configured differently.

In this respect exemplary embodiments can provide bearing assemblies 100 and 400, which, for example, support a pinion shaft 200 of a motor-vehicle driveline. As the above-described bowl-shaped designs of the bearing-outer-ring assemblies 110 show, these bearing assemblies can partially include, at least on one side, bearing rings including bearing raceways, which bearing rings are manufactured from a thin material such as, for example, steel plate, by reshaping, e.g., deep-drawing. In other words, such a pot-type or bowl-type shape can be manufactured cost-effectively and serve in exemplary embodiments as bearing-outer-ring assembly 100. In further exemplary embodiments the bearing assembly 500 can comprise, for example, a pinion shaft 200 of a motor-vehicle driveline, and, as explained above, a common bearing-outer-ring assembly 110 for the bearing assembly 100 and 400.

In comparison to the exemplary embodiments explained above, bowl-, pot-, or also L-shaped components 160 and 162 are first to be recognized in the exemplary embodiment of FIG. 7. As already followed from the preceding exemplary embodiments, the bearing-outer-ring assembly 110 and/or the bearing-inner-ring assembly 120 can include recesses with raceways for the rolling-element rows 130 and 140. In the exemplary embodiment of FIG. 7 the bearing ring assemblies 110 and 120 are configured as components, which from their design resemble a bowl. In this respect the bearing-outer-ring assembly 160 is configured as a bowl-shaped, pot-shaped, or in cross-section nearly L-shaped component that provides the raceways for the rolling elements, in this exemplary embodiment the balls and cones. In other exemplary embodiments such a bowl-shaped component can also be brought between the rolling elements and the actual bearing-outer-ring assembly 110 or bearing-inner-ring assembly 120, as will be explained in more detail in the following.

In other words, in exemplary embodiments a bearing-inner-ring assembly 110, 120 can have a bowl-shaped design 160, 162. FIG. 8 illustrates a further exemplary embodiment wherein the second bearing assembly 400 includes only one rolling-element row 430. As follows from comparison of the two load directions 432 for the rolling-element rows 430 of the bearing assembly 400 with the load axis 132 of the rolling-element row 130 of the bearing assembly 100, these two bearings form a back-to-back arrangement with respect to each other. This can offer advantages in load distribution. Of course in other exemplary embodiments a face-to-face arrangement is also conceivable.

A further exemplary embodiment is depicted in FIG. 9. FIG. 9 shows an exemplary embodiment having an angle difference of the load angle inside the bearing assembly 100 of nearly 90°. Here FIG. 9 shows a bowl-shaped bearing outer ring, which corresponds to the short arm of the L-shaped structure 162 in FIG. 9, which provides surfaces for the rolling-element row. In the present exemplary embodiment this forms an axial bearing. The second rolling-element row is formed by the tapered-roller row 140 and in this exemplary embodiment represents a radial bearing. In this exemplary embodiment the bearing assembly 400 is also configured as an axial bearing, which supports loads in the opposite (axial) direction in comparison to the axial-bearing row 130. In the exemplary embodiment of FIG. 9 the bearing-outer-ring assembly 110 has a bowl-shaped design, in whose base region the raceway or even a separate raceway of a further bearing row can be located. Such an exemplary embodiment is depicted in FIG. 10. At the location of the raceway of the rolling-element row 130 FIG. 10 shows a ring 164 that forms the raceway for the rolling-element row 130. As an example of a further design the bearing arrangement 400 in FIG. 10 is shown as an angular contact ball bearing. The exemplary embodiment of FIG. 10 shows that the ring 164 is located on the base of the bowl-shaped design of the bearing outer ring 162 and forms the corresponding raceway.

FIG. 11 illustrates a further exemplary embodiment of the bearing assemblies 100 and 400, wherein for the bearing assembly 500 the pinion shaft 200 has already been integrated with the bearing inner ring 120, i.e., in the exemplary embodiment of FIG. 1 the shaft 200 is configured one-piece with the bearing inner ring or the bearing-inner-ring assembly 120 of the first bearing assembly 100. Of course in further exemplary embodiments a corresponding shaft 200 can also comprise a bearing-inner-ring assembly 420 of the second bearing assembly 400. In this respect exemplary embodiments can also provide a pinion shaft 200 of a motor-vehicle driveline, wherein the rolling-element bearing assemblies 100 and 400 on at least one side at least partially include bearing rings including bearing raceways, which bearing rings are integrated into the shaft 200.

FIG. 12 illustrates a further exemplary embodiment of a bearing assembly 100, including a first rolling-element row 130, which is configured as a tapered-roller row, and a second rolling-element row 140, which is configured as a ball row as part of an angular contact ball bearing. In this respect the tapered-roller row serves as a radial bearing and the ball row as an angular contact ball bearing, as the two axes 132 and 142 show. The exemplary embodiment of FIG. 12 illustrates a rolling-element bearing unit 100 including rolling-element rows 130 and 140, which are guided by a cage or a cage component 170, 180, which is engaged/snapped-in into a guide groove, preferably in the outer ring 110. Here the exemplary embodiment of FIG. 12 shows two cage components 170 and 180, which guide the two rolling-element rows separately from each other. However, in exemplary embodiments a guide groove in one of the bearing rings 110 or 120 can be provided for both cage components 170 and 180. In this respect the exemplary embodiment of FIG. 2 shows a bearing assembly 100, which includes at least one bearing cage 170 or 180 for guiding the first or the second rolling-element rows 130 and 140. The bearing cage 170 or 180 further comprises a guide means, for example in the form of a groove or a lug, which interacts with the bearing-outer-ring assembly 110 or the bearing-inner-ring assembly 120 for guiding the bearing cage 170 or 180 relative to the bearing-outer-ring assembly 120 or the bearing-inner-ring assembly 110. In an analogous manner the bearing-inner-ring assembly 120 or the bearing-outer-ring assembly 110 can include a corresponding groove into which the corresponding lug or an extension of a bearing cage 170 or 180 can engage in order to then be guided on the bearing cage.

FIG. 13 illustrates a further exemplary embodiment wherein a first rolling-element row 130 is embodied as a cylindrical-roller row, which is guided by a cage 170. In addition, between the second rolling-element row 140 and the bearing-outer-ring assembly 110 a bowl-shaped component 162 is located, which here forms a raceway for the second rolling-element row 140, which in this exemplary embodiment is embodied as an angular contact ball bearing. FIG. 14 shows a further exemplary embodiment of bowl-shaped designs or bowl-shaped components 162 and 164, which in this exemplary embodiment serve both as bearing-outer-ring assemblies 110 and as bearing-inner-ring assemblies 120. In this exemplary embodiment the first rolling-element row 130 is in turn formed by tapered rollers, and the second rolling-element row 140 by corresponding balls. As the bowl-shaped components 162 and 164 show, here the second rolling-element row 140 forms an angular contact ball bearing. This is achieved in that the bowl-shaped component is brought into a corresponding form, for example, by deep-drawing or cold working of a metal plate. In addition, for reinforcing, still further components can be located between the respective bowl-shaped arrangements and the shaft 200 or the housing 300.

Finally FIG. 15 shows a further exemplary embodiment of the pinion shaft 200 including the pinion 210. As the exemplary embodiment of FIG. 15 shows, the two bearing assemblies 100 and 400 shown are equipped with a common bearing-outer-ring assembly 110, which in the present case is formed from said bowl-shaped part or component 162. In addition, in FIG. 15 in total four rolling-element rows are shown, wherein the two rolling-element rows 430 and 130 are configured as tapered rollers and the two rolling-element rows 140 and 440 form two angular contact ball bearings in back-to-back arrangement.

Here FIGS. 7 to 10 as well as 15 show exemplary embodiments wherein in the first bearing assembly 100 the first rolling-element row 130, which realizes an axial or radial bearing, is located on the side of the bearing assembly 100 facing the pinion 210. Accordingly the second rolling-element row 140 of the first bearing arrangement 100 is located farther removed from the pinion 210 than the first rolling-element row 130. This exemplary embodiment shows the second rolling-element row 140 on the side of the bearing assembly 100 facing away from the pinion 210.

In addition, in exemplary embodiments the corresponding bearing assemblies can be correspondingly sealed, oil-lubricated, and grease-lubricated. With regard to the materials used, appropriate metals can be used for the bearing assemblies, the housing, and the shaft. For example, a housing can be formed by a light metal such as aluminum.

The features disclosed in the foregoing description, the following claims, and the accompanying Figures can be meaningful and can be implemented both individually as well as in any combination for the realization of an exemplary embodiment in its various designs.

The above-described exemplary embodiments represent only an illustration of the principles of the present invention. It is understood that modifications and variations of the arrangements and details described herein will be clear to other persons of skill in the art. It is therefore intended that the invention be limited only by the scope of the following patent claims, and not by the specific details which have been presented with reference to the description and the explanation of the exemplary embodiments.

### REFERENCE NUMBER LIST

100 Bearing assembly
110 Bearing-outer-ring assembly
120 Bearing-inner-ring assembly
130 First rolling-element row
132 First rolling-element-row load direction/axis
140 Second rolling-element row
142 Second rolling-element-row load direction/axis
150 Third rolling-element row
152 Third rolling-element-row load direction/axis
122 Partial bearing-inner-ring
124 Partial bearing-inner-ring
160 Bowl-shaped component
162 Bowl-shaped component
164 Ring including raceway
170 Bearing cage
180 Bearing cage
200 Shaft
210 Pinion
300 Housing
400 Bearing assembly
410 Bearing-outer-ring assembly
420 Bearing-inner-ring assembly
430 Rolling-element row
432 Rolling-element-row load direction/axis
440 Clamping ring
500 Bearing assembly
600 Spacer
610 Preload element

1. The bearing assembly for supporting a shaft the bearing assembly including a bearing-outer-ring assembly, a bearing-inner-ring assembly, a first rolling-element row configured to support the bearing-outer-ring assembly with respect to the bearing-inner-ring assembly in an axial or a radial direction, and a second rolling-element row configured to support the bearing-outer-ring assembly with respect to the bearing-inner-ring assembly in a direction that differs from the axial direction and differs from the radial direction, wherein the bearing-outer-ring assembly or and/or the bearing-inner-ring assembly is separated from the first or the second rolling-element row by a bowl-shaped component, and wherein the bowl-shaped component includes at least one raceway for the first rolling-element row or for the second rolling-element row.

2. The bearing assembly according to claim 1, wherein the bearing-outer-ring assembly includes first and second raceways for rolling elements of the first and of the second rolling-element rows, and wherein the bearing-outer-ring assembly is configured one-piece or multiple-piece, or wherein the bearing-inner-ring assembly includes two raceways for rolling elements of the first and of the second rolling-element rows, and wherein the bearing-inner-ring assembly is configured one-piece or multiple-piece.

3. The bearing assembly according to claim 1, wherein the rolling elements of the first and of the second rolling-element row are configured as balls, cones, cylinders, barrels, or needles, and wherein the rolling elements of the first rolling-element row are configured different than the rolling elements of the second rolling-element row.

4. The bearing assembly according to claim 1, wherein the bearing-outer-ring assembly or the bearing-inner-ring assembly includes a recess including a raceway for one of the rolling-element rows.

5. The bearing assembly according to claim 1, including at least one bearing cage for guiding the first rolling-element row or the second rolling-element row, wherein the bearing cage includes a guide that interacts with the bearing-outer-ring assembly or the bearing-inner-ring assembly for guiding the bearing cage relative to the bearing-outer-ring assembly or the bearing-inner-ring assembly.

6. A bearing arrangement for supporting a pinion shaft having a pinion, which bearing arrangement includes a first bearing assembly according to claim 1 and a second bearing assembly, wherein the first bearing assembly is mounted on the pinion shaft between the second bearing assembly and the pinion.

7. The bearing arrangement according to claim 6, wherein in the first bearing assembly the first rolling-element row faces the pinion and/or wherein the bearing arrangement further comprises a stable or deformable spacer.

8. The bearing arrangement according to claim 6 further including a preload element configured to axially preload the first bearing assembly with respect to the second bearing assembly.

9. The bearing arrangement according to claim 6, wherein the second bearing assembly comprises an angular bearing, an axial bearing, or a radial bearing, the second bearing being disposed in minor image with respect to the first bearing assembly.

10. A pinion shaft for the bearing arrangement according to claim 6 including at least one bearing inner ring of the first bearing assembly or of the second bearing assembly.

11. The bearing assembly according to claim 1, further including at least one bearing cage for guiding the first rolling-element row or the second rolling-element row, wherein the bearing cage includes a guide that interacts with the bearing-outer-ring assembly or the bearing-inner-ring assembly for guiding the bearing cage relative to the bearing-outer-ring assembly or the bearing-inner-ring assembly, and
wherein the bearing-outer-ring assembly includes first and second raceways for rolling elements of the first and of the second rolling-element rows, and wherein the bearing-outer-ring assembly is configured one-piece or multiple-piece, or wherein the bearing-inner-ring assembly includes two raceways for rolling elements of the first and of the second rolling-element rows, and wherein the bearing-inner-ring assembly is configured one-piece or multiple-piece, and
wherein the rolling elements of the first and of the second rolling-element row are configured as balls, cones, cylinders, barrels, or needles, and wherein the rolling elements of the first rolling-element row are configured different than the rolling elements of the second rolling-element row.

12. The bearing assembly according to claim 1, wherein the first rolling-element row us configured to support the bearing-outer-ring assembly in only the axial direction or in only the radial direction.

13. A bearing assembly for supporting a shaft the bearing assembly comprising:
a bearing outer ring assembly,
a bearing inner ring assembly,
a first rolling-element row between the bearing outer ring assembly and the bearing inner ring assembly configured to support the bearing outer ring assembly with respect to the bearing inner ring assembly only in an axial direction or only in a radial direction, and
a second rolling-element row between the bearing outer ring assembly and the bearing inner ring assembly configured to support the bearing outer ring assembly with respect to the bearing inner ring assembly in a direction different from the axial direction and different from the radial direction,
wherein the bearing outer ring assembly or the bearing inner ring assembly is separated from the first or the second rolling-element row by a spacer mounted on the bearing outer ring assembly or on the bearing inner ring assembly, the spacer including an arcuate portion defining at least one raceway for rolling elements of the first rolling-element row or the second rolling-element row.
